(19) United States
(12) Patent Application Publication
(10) Pub. No.: US 2025/0220075 A1
(43) Pub. Date: Jul. 3, 2025

(54) TCP Service Discovery for Stateful Inline Network Devices

(71) Applicant: runZero, Inc., Austin, TX (US)

(72) Inventor: HD Moore, Austin, TX (US)

(73) Assignee: runZero, Inc., Austin, TX (US)

(21) Appl. No.: 18/923,253

(22) Filed: Oct. 22, 2024

Related U.S. Application Data
(60) Provisional application No. 63/616,907, filed on Jan. 2, 2024.

(51) Int. Cl. H04L 67/1095; H04L 67/51

(52) U.S. Cl. CPC H04L 67/1095; H04L 67/51

(57) ABSTRACT

Systems and methods for monitoring and discovering assets (e.g., computing devices) connected to a computer network are disclosed. A network scanner is communicatively coupled to one or more devices through one or more inline stateful network devices. Examples of inline stateful network devices may include routers and switches. The network scanner transmits a synchronize (SYN) request to a transmission control protocol (TCP) port for every internet protocol (IP) address on the computer network. After transmitting a SYN packet to one or more TCP ports for each IP address, the network scanner transmits a RST request to the IP address and TCP port after a predetermined delay based on an expected response time for a network, causing the inline stateful network device to remove the session from memory and prevent potential issues including memory overloading and dropping of valid network traffic.

### CROSS-REFERENCE TO RELATED APPLICATION(S)

This application claims the priority benefit, under 35 U.S.C. 119 (e), of U.S. Application No. 63/716,907, filed Jan. 2, 2024, and entitled “TCP Service Discovery for Stateful Inline Network Devices,” which is incorporated herein by reference in its entirety for all purposes.

### BACKGROUND

Many modern organizations, including companies and universities, operate computer networks that include thousands of computers, routers, switches, printers, and other networked electronic devices. These devices can run a wide variety of operating systems and applications and store many different types of data, including potentially sensitive data, such as financial information or health records. Because there are so many devices on these computer networks, and because these devices usually aren't controlled by a single entity, it can be challenging to ensure that these devices are being managed and used effectively and secured from cybersecurity threats. With so many devices and users, it can be challenging to simply know which devices are connected to or part of such a large, diverse computer network, especially when devices are added to and removed from the computer network every day.

### SUMMARY

Network-based discovery of cyber assets involves either listening for traffic from or sending traffic to network nodes based on their internet protocol (IP) addresses. Asset discovery is one step in the process of protecting the computer network from cybersecurity threats. When performed properly, asset discovery identifies every device on the computer network, including unmanaged devices, which are often not patched with the latest security updates and can therefore be vulnerable to intruders. Asset discovery can also identify misconfigured devices and unmanaged network segments, both of which can leave a computer network vulnerable to attack.

Conventional active asset discovery typically involves transmitting transmission control protocol (TCP) synchronize (SYN) packets from a network scanner to one or more TCP ports on some or all of the computer network's IP addresses. Each initial SYN packet has a sequence number and the SYN flag bit set. A device connected to one of these IP addresses and offering a service on one of these TCP ports should respond to the SYN packet with a synchronize/acknowledge (SYN/ACK) packet with both the SYN and ACK flag bits set and confirmation of the original sequence number. This SYN/ACK packet indicates that the network node is active and that the specific TCP port reached is available and offering an application service, such as a web server or file store. An active network node that is not offering a TCP service on that port may respond with a reset (RST) packet instead, or not respond at all, depending on the presence of a firewall. A request sent to an inactive network node will either receive no response at all or an internet control message protocol (ICMP) error from the last-hop router indicating that the host was unreachable.

In many cases, the network scanner transmits the SYN packet via one or more intermediate or inline stateful network devices, such as firewalls, routers, bridges, modems, repeaters, switches, and the like, between the network scanner and the destination of the SYN packet. Stateful devices are common in high-security environments as they are used to detect attacks and enforce network segmentation. Many of the devices crossed by traffic traversing between IP networks are inline stateful network devices. When a stateful network device observes a SYN packet, it defines a session for the sequence number encoded in the SYN packet. If a network node receives and responds to the SYN packet with a SYN/ACK response, then the stateful network device leaves the session open until the connection is closed through the use of a RST or FIN packet, or a predetermined timeout period has elapsed, at which point the stateful network device closes the session. (A FIN packet gracefully requests the termination of a TCP connection, whereas a RST packet forces termination of the TCP connection.) If no device responds to the SYN packet, or no further communication occurs after the SYN/ACK response, then the stateful network device leaves the session open until a predetermined timeout period has elapsed.

A stateful device can have different timeouts for each stage-a single SYN packet could define a short-lived session (e.g., 60 seconds), whereas a SYN-ACK response could define a longer session (e.g., 5 minutes), and a full handshake (SYN, SYN/ACK, ACK) could have a timeout closer to one hour. There can be multiple stateful devices tracking state in the network path, each using different timeout values, making it difficult to predict or test the timeouts of a given stateful device from the network side. Many of these stateful devices appear passive to the network participants, at least until they run out of memory to store session state entries and crash.

If the network scanner is scanning many (e.g., hundreds to thousands) of TCP ports, then it may open many (e.g., hundreds to thousands) sessions on a given intermediate or inline stateful network device. And if the sessions are opened faster than they expire or are closed, they can accumulate in a stateful network device's memory. Unfortunately, stateful network devices have finite memory for storing sessions. Opening too many sessions on a given intermediate or inline stateful network device may exhaust that stateful network device's memory. Once an inline stateful network device runs out of memory, it may drop existing sessions or stop accepting new sessions (SYN packets). This can slow down or stop asset discovery by the network scanner and impact normal network traffic processing.

The present technology addresses this problem with network scanning somewhat counterintuitively: the network scanner pre-emptively resets the intermediate stateful network device after every SYN packet. This closes the session table entries almost immediately after they are opened, preventing session table entries from accumulating in the memory of an inline stateful network device. Using pre-emptive TCP reset (RST) requests or packets to manage the session tables of inline stateful network devices improves the safety, speed, and resource utilization of active TCP service discovery.

More specifically, a method of discovering assets on a computer network can include, for each of at least a subset of the computer network's IP addresses, transmitting a SYN request from a network scanner to a TCP port on that IP address via an intermediate stateful network device. The SYN request causes the intermediate stateful network device to open a session table entry in memory. Transmitting a RST request to the TCP port on that IP address via the intermediate stateful network device causes the intermediate stateful network device to clear the session table entry from the memory.

The RST request can be transmitted by the network scanner or by a device at that IP address. Transmitting the RST request can comprise setting a time-to-live (TTL) of the RST request to be at least equal to a hop count from the network scanner to the intermediate stateful network device. The TTL of the RST request can also be set to less than a hop count from the network scanner to a device at that IP address. After the RST request has been transmitted, the network scanner may transmit a subsequent SYN request to a different TCP port at that IP address. The scanner can send requests to multiple ports at a time and does not need to reset each session to try another port.

There can be a delay period between transmitting the SYN request and transmitting the RST request. This delay period can be based on a response time of another device on the same network segment as that IP address, a round-trip time (RTT) between the network scanner and the intended destination of the SYN request, or any suitable factor.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar components).

FIG. 1 shows a computer network with a network scanner, inline stateful network devices, and devices at different internet protocol (IP) addresses.

FIG. 2 shows a block diagram of the network scanner of FIG. 1.

FIG. 3 illustrates a network scanner sending successive transmission control protocol (TCP) synchronize (SYN) requests to a TCP port on an unused IP address via a stateful network device, which allocates a different session table entry to each SYN request.

FIG. 4 illustrates a network scanner sending successive SYN requests with the same sequence (SEQ) number to a TCP port on an unused IP address via a stateful network device, which allocates a single session table entry to the SYN requests.

FIG. 5 illustrates a network scanner sending successive SYN and reset (RST) requests with the same sequence number to a TCP port on an unused IP address via a stateful network device. The stateful network device opens a session in response to each SYN request and closes the session in response to the following RST request.

FIG. 6 illustrates a target device responding to a SYN request with a RST request that clears the session for the SYN request in a stateful network device between the network scanner and the target device.

### DETAILED DESCRIPTION

Transmission control protocol (TCP) service discovery is useful in identifying network connected devices and services within computer networks, including the internet as a whole. TCP service discovery typically involves sending TCP synchronize (SYN) requests or packets from one or more network scanners to each of a number of common TCP port numbers on every in-scope internet protocol (IP) address. Typically, a network scanner sends many requests per second, typically at a much higher rate than a single network client (e.g., 1,000 SYN requests per second). Most scanners can send SYN requests at configurable rates, so it is common to send SYN requests at a higher rate, e.g., 10,000 per second or more, in an effort to reduce the overall network discovery time. This process can result in thousands of requests per destination IP address and the creation of millions of session table entries in the memories of inline stateful network devices between the network scanner and multiple destination IP addresses. This problem is most apparent when a low-resource device, such as a small office router or firewall, is the inline stateful network device in the network path between the network scanner and a large number of unused IP addresses, such as a sparsely allocated IPv4 block.

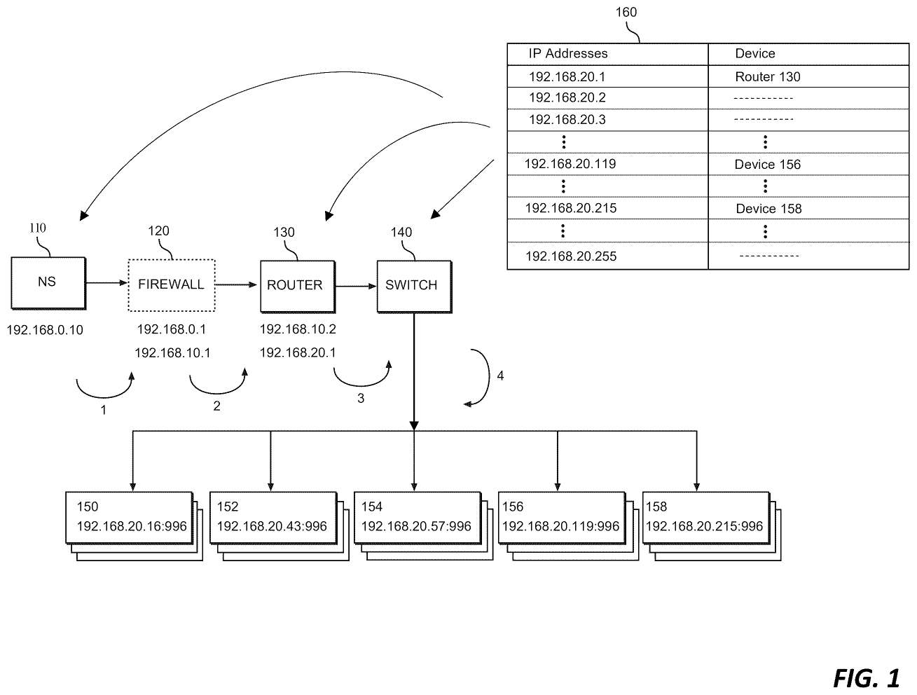

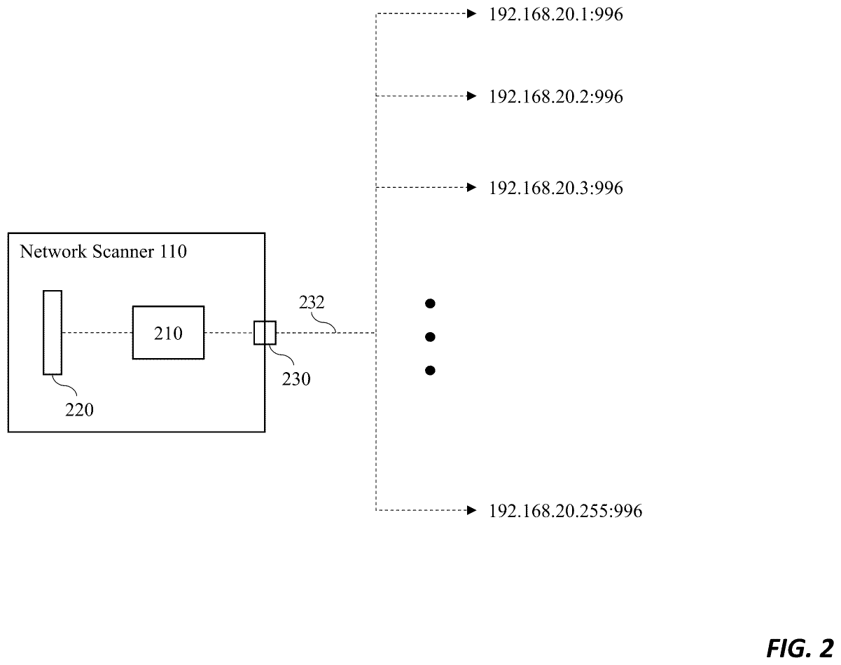

FIG. 1 illustrates a computer network 100 communicatively coupled with a network scanner 110. Network 100 may be located in any suitable environment (e.g., within a room, a building, an office, a stadium, or the like) or distributed across physically separated environments (e.g., distributed across buildings, across states, across countries, across continents, or the like). Network scanner 110 may be configured to perform any of the methods, steps, and/or functions disclosed herein. Network scanner 110 and exemplary components are illustrated in greater detail in FIG. 2. Network scanner 110 may be communicatively coupled to one or more devices such as device 150, device 152, device 154, device 156, and device 158, each of which may have a corresponding IP address. For example, network scanner 110 may be communicatively coupled to devices of computer network 100 through one or more inline stateful network devices, such as firewall 120, router 130, and switch 140. Network scanner 110, firewall 120, and router 130 may each have one or more IP addresses. Examples of inline stateful network devices may further include bridges, repeaters, modems, and the like. FIG. 1 depicts network scanner 110 having IP address 192.168.0.10, firewall 120 having IP addresses 192.168.0.1 and 192.168.10.1, router 130 having IP addresses 192.168.10.2 and 192.168.20.1, device 150 having IP address 192.168.20.16, device 152 having IP address 192.168.20.43, device 154 having IP address 192.168.20.57, device 156 having IP address 192.168.20.119, and device 158 having IP address 192.168.20.215.

Each inline stateful network device may include a memory configured to store a representation or state of the network. For example, some or all inline stateful network devices may include a representation, e.g., IP table 160, of which devices are connected to the network, each device's IP address, how long each device has been connected to the network, or any suitable information. However, network scanner 110 may have records of only some or none of devices 150-158, in other words some or all of devices 150-158 may not be “known” to network scanner 110.

FIG. 1 further illustrates a hop count for exemplary data packets transmitted from network scanner 110 to a device such as device 150. A packet transmitted from network scanner 110 to device 150 may pass through firewall 120, router 130, switch 140, and finally to device 150 for a total hop count of 4. A time-to-live (TTL) for packets transmitted through computer network 100 may be set based on a number of inline stateful network devices between network scanner 110 and a target device, and is described in further detail below.

FIG. 2 illustrates the network scanner 110 in accordance with the present technology as well as IP addresses to which network scanner 110 may transmit SYN requests in order to determine which devices are connected to a network. Network scanner 110 may include a processor 210, a memory 220 communicatively coupled to processor 210, and a network interface card (NIC), NIC 230. NIC 230 may provide an interface between processor 210 and computer network 100, including inline stateful network devices and target devices. Network scanner 110 may transmit SYN requests 232 to each IP address of a network (e.g., to each IP address from 192.168.0.1 to 192.168.0.255), and more particularly to one or more ports associated with each IP address, such as port 996.

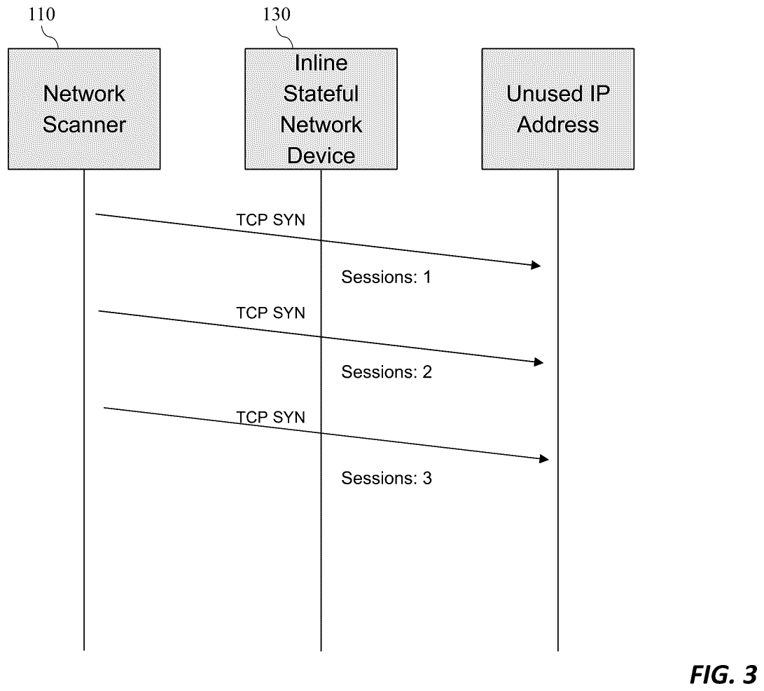

FIG. 3 illustrates the session table behavior of an inline stateful network device 130 when a network scanner 110 sends three SYN requests or packets using the same source IP address, destination IP address, and destination TCP port but different source TCP ports. The quad typically use the same sequence number, but a naive port scanner using native operating system socket application programming interfaces (APIs) may try to open the connection three times, each with a different source port and sequence number. Network scanner 110 sends multiple requests to handle temporary packet loss—it is very common for a single request to get lost—so network discovery processes retry each request that does not see a response as a result.

These SYN requests propagate from network scanner 110 to the TCP port via inline stateful network device 130, which may be a firewall, router, switch, or other device. When inline stateful network device 130 receives each SYN request, it creates a session table entry in its memory for that SYN request, whether or not there is a device at the IP address. In some cases, each SYN request may transit several inline stateful network devices, for example, from network scanner 110 to the destination via a first router, intrusion detection/protection system, firewall, and second router. In these cases, each inline stateful network device may create a session table entry for the SYN request in its own memory. Some of these stateful devices pass through traffic, while processing the traffic to detect security events, while others are inline and are responsible for forwarding traffic from the source to the destination.

Each session table entry persists in the corresponding inline stateful network device's memory for a timeout period that depends on the response to the SYN request. If there is an active network device at a SYN request's destination, then network scanner 110 should receive that network device's response within about 5 milliseconds for an internal network or within about 200 milliseconds for cross-internet traffic, although these periods vary widely. The response may be a RST packet, which closes the session immediately, or a SYN+ACK response, which indicates that a program is bound to this port and available for communication. A SYN+ACK response keeps the session open within the stateful inline network device for an even longer timeout period—until inline stateful network device 130 sees an ACK packet (for a full connection) from the target device or a RST/FIN packet from either network scanner 110 or the target device.

Unfortunately, not every SYN request provokes a response—in many cases, there is no active network device at the SYN request's destination port or IP address. The session table entries for unanswered SYN requests persist in each inline stateful network device's memory until they expire, which can take minutes to hours, depending on inline stateful network device 130 and how it is configured. Over time, unanswered SYN requests can cause session table entries to accumulate in the memory of inline stateful network device 130. An inline stateful network device's maximum session state (the maximum number of session table entries that can be stored in the memory of inline stateful network device 130) can vary widely, e.g., from about 1000 or so on the low end to a few million on the high end. The timeout period can also vary among inline stateful network devices. Unfortunately, it can be challenging to determine or predict an inline stateful network device's maximum session state or timeout period(s) before scanning the network. In many cases, network scanner 110 is not aware of any or all of inline stateful network device 130s between the host system and the destination networks.

If enough session table entries accumulate in inline stateful network device 130's memory, inline stateful network device 130 will malfunction, for example, by dropping existing sessions or not opening new sessions. This impedes network scanner 110's ability to send new SYN requests and to complete the three-part handshake for SYN requests that have been received by other devices on the computer network. If network scanner 110 cannot complete SYN handshakes or send new SYN requests, then it may not be able to identify or discover every asset connected the computer network, at least not without delays.

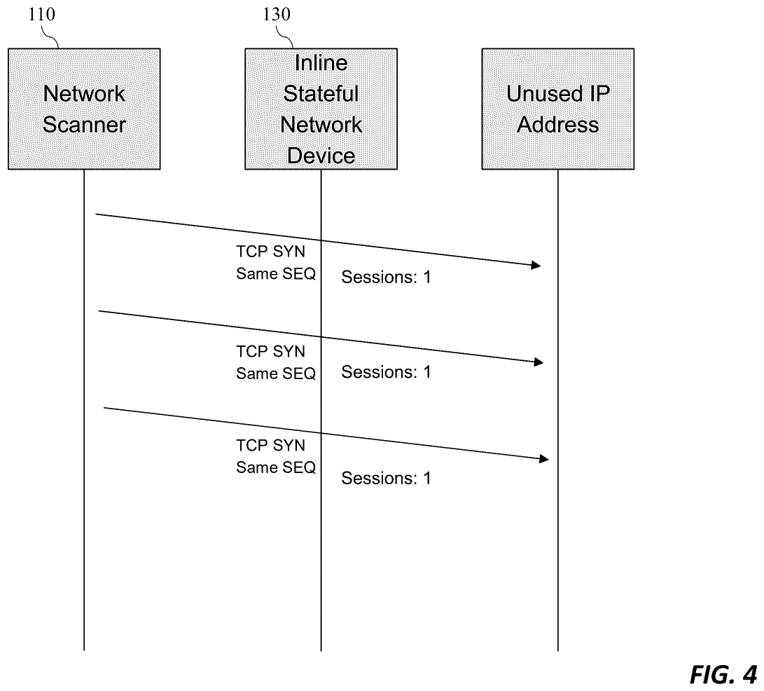

FIG. 4 illustrates an alternative approach for asset discovery. In this approach, network scanner 110 sends multiple SYN requests with the same quad (src port/src ip address/dst port/dst ip address) and same TCP sequence number, with delays between each request. In other words, network scanner 110 sends a SYN request and waits for a response. If network scanner 110 receives a response, it moves to the next target; if not, it sends the same SYN request again and waits for a response. Network scanner 110 repeats this process one more time and returns an error if it does not receive a response from the target.

In FIG. 4, network scanner 110 sends multiple SYN requests to compensate for packet loss, but because the SYN requests have same TCP sequence number and unique combination of source IP, source port, destination IP, and destination port, inline stateful network device 130 allocates a session to all of the SYN requests with the same quad. Because several SYN requests “share” the same session, inline stateful network device 130 stores fewer session table entries in its memory. But even though allocating one session to multiple SYN requests reduces memory consumption at inline stateful network device 130, inline stateful network device 130 still maintains at least one session table entry per unique combination of source IP address, source TCP port, destination IP address, and destination TCP port probed by network scanner 110. If there isn't a device at the destination IP address, then inline stateful network device 130 maintains these session table entries in memory until reaching a timeout.

Even though inline stateful network device 130 accrues session table entries at a lower rate, the session table entries can still accrue faster than they expire. For example, if network scanner 110 sends 10,000 SYN requests per second, across 500 TCP ports, and against a large network segment (e.g., an IPv4/16 block, which represents 65,536 IP addresses), inline stateful network device 130 may accumulate millions of session table entries. This can cause inline stateful network device 130 to become overloaded, shut down, or drop valid traffic, all of which cause serious problems in a production environment (operating computer network).

Other previous approaches to reducing usage of the memories of inline stateful network devices during asset discovery include reducing the scan speed or scanning around bottlenecks (inline stateful network devices), but these other approaches come at the cost of increased scan time and more complicated network configurations.

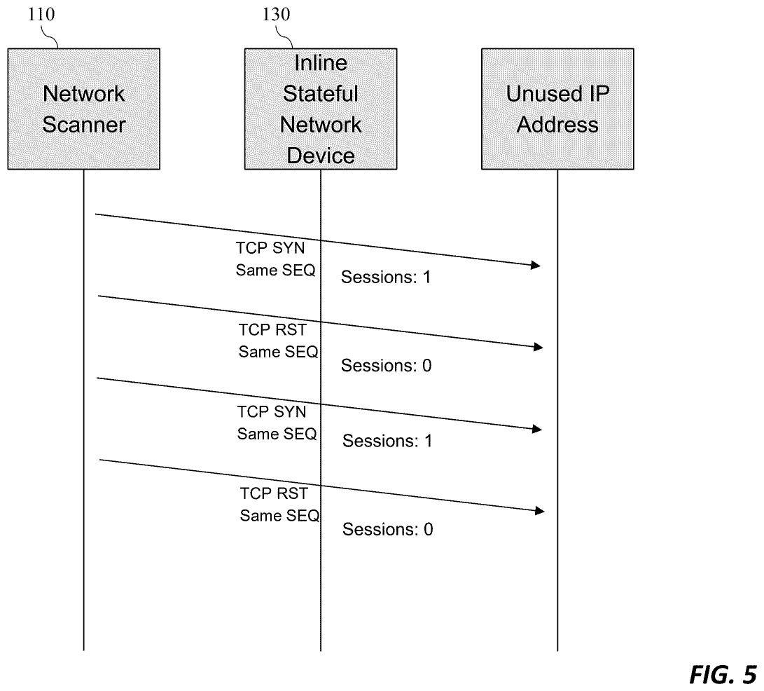

FIG. 5 shows an inventive, counterintuitive approach to managing the state table of an inline stateful network device during asset discovery. In this approach, network scanner 110 pre-emptively sends a RST request after each SYN request, with the specific delay between the SYN and RST requests and various optimizations based on the specific environment. This delay is tunable and can be set based on the predicted round-trip time between network scanner 110 and the target, as explained below. Each SYN request opens a session in inline stateful network device 130 as described above with respect to FIG. 3. And each RST request clears the last session opened by inline stateful network device 130, preventing session table entries from accruing in inline stateful network device 130's memory. In other words, this process effectively clears sessions from inline stateful network device 130 automatically as part of the scanning process, limiting the number of session table entries in inline stateful network device 130's memory.

On its face, this approach appears slower than a conventional asset discovery process. because it involves sending up to twice as many requests—one RST request for each unanswered SYN request—than a conventional asset discovery process. But by reducing or eliminating interruptions caused by stateful network devices with too many session table entries in memory, this approach to asset discovery is faster and safer than a conventional asset discovery process. Put differently, by clearing the memories of inline stateful network devices with RST requests, an inventive network scanner can scan a computer network at a higher average speed (if not a higher peak speed) than a conventional network scanner because it does not overload the memories of inline stateful network devices or cause network outages due to session table limits or device crashes.

If desired, network scanner 110 can set the IP “Time to Live” (TTL) field of the RST packet such that inline stateful network device 130 sees the RST packet, but the end target device does not. This can be configured by setting the TTL of the RST packet to be at least one hop less than the hop count to the target network, and at least the hop count to the last known inline stateful network device. This ensures that the RST packet reaches inline stateful network device 130 while reducing the latency associated with the RST packet and the delay between successive SYN packets. By setting the TTL, network scanner 110 can choose which stateful network devices observe the RST packet and which do not. By setting the hop count to be less than the hop count to the target network, network scanner 110 reduces bandwidth consumption by causing the RST packet to expire before it reaches the final segment.

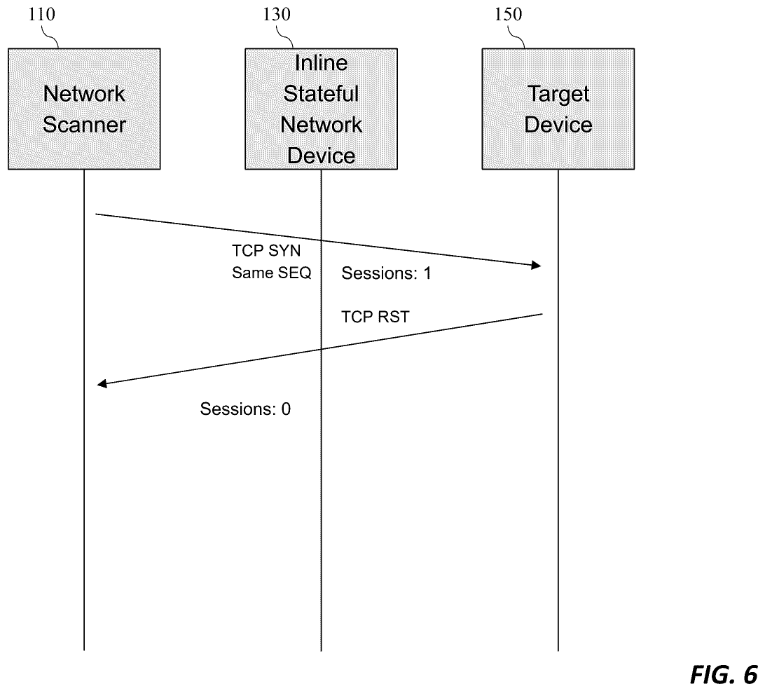

In cases where the network scan is performed against an in-use IP address without packet filters in place, additional optimization can be performed by delaying the RST packet by at least as long, if not longer, as the measured response time from the target device. This can result in less resource usage by inline stateful network device 130. In FIG. 6, for example, the target device responds with a RST packet, which clears the inline network device session, so network scanner 110 does not need to send a RST packet, saving at least one packet. In many cases, a target device will send a RST packet on some ports, but not others, which means that network scanner 110 should still send RST packets to ports from which the target device does not reply within a given time window.

The delay between sending a SYN request and the succeeding RST packet can be chosen based on the network itself. Devices on internal networks typically take less than 5 milliseconds to respond, whereas devices on external networks can take 200 milliseconds or longer to respond, suggesting delays of equal to or greater than 5 milliseconds for internal networks and greater than or equal to 200 milliseconds (ms) for external networks. For example, if the target's response is expected within 5 ms, then the delay may be 20 ms. Network scanner 110 can also choose the delay based on the response time from an existing reply on the same segment as the target or from the final router of that segment. Additionally or alternatively, a ping request (ICMP) to the last-hop router may provide an indication of how long (in milliseconds) it takes to get a packet from the last-hop router to the destination and back. Setting the RST delay to be the full RTT may ensure that real response from the target device (if present) will be received prior to the scanner sending the RST.

In practice, it can be convenient to set the delay before sending the RST packet to a value based on the scan rate—for a higher scan rate, the delay should be shorter, whereas if the scan rate is relatively low, the delay can be longer without ill effect. One approach is to send each RST packet 50 milliseconds after the corresponding SYN packet, since that almost always keeps the intended order in inline stateful network device 130. Even if the target device receives the SYN and RST packets out of order, it should not impact the accuracy of the scans.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the components so conjoined, i.e., components that are conjunctively present in some cases and disjunctively present in other cases. Multiple components listed with “and/or” should be construed in the same fashion, i.e., “one or more” of the components so conjoined. Other components may optionally be present other than the components specifically identified by the “and/or” clause, whether related or unrelated to those components specifically identified. Thus, as a non-limiting example, a reference to “A and/or B”, when used in conjunction with open-ended language such as “comprising” can refer, in one embodiment, to A only (optionally including components other than B); in another embodiment, to B only (optionally including components other than A); in yet another embodiment, to both A and B (optionally including other components); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of components, and, optionally, additional unlisted items. Only terms clearly indicated to the contrary, such as “only one of” or “exactly one of,” or, when used in the claims, “consisting of,” will refer to the inclusion of exactly one component of a number or list of components. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more components, should be understood to mean at least one component selected from any one or more of the components in the list of components, but not necessarily including at least one of each and every component specifically listed within the list of components and not excluding any combinations of components in the list of components. This definition also allows that components may optionally be present other than the components specifically identified within the list of components to which the phrase “at least one” refers, whether related or unrelated to those components specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including components other than B); in another embodiment, to at least one, optionally including more than one, B, with no A present (and optionally including components other than A); in yet another embodiment, to at least one, optionally including more than one, A, and at least one, optionally including more than one, B (and optionally including other components); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of discovering assets on a computer network, the method comprising, for each of at least a subset of internet protocol (IP) addresses of the computer network:
transmitting, by a network scanner, a synchronize (SYN) request to a TCP port on that IP address via an intermediate stateful network device, the SYN request causing the intermediate stateful network device to open a session table entry in memory; and
transmitting a reset (RST) request to the TCP port on that IP address via the intermediate stateful network device, the RST request causing the intermediate stateful network device to clear the session table entry from the memory.

2. The method of claim 1, wherein transmitting the RST request is by the network scanner.

3. The method of claim 1, wherein transmitting the RST request is by a device at that IP address.

4. The method of claim 1, wherein transmitting the RST request comprises setting a time-to-live (TTL) of the RST request to be at least equal to a hop count from the network scanner to the intermediate stateful network device.

5. The method of claim 4, wherein transmitting the RST request further comprises setting the TTL of the RST request to be less than a hop count from the network scanner to a device at that IP address.

6. The method of claim 1, further comprising, after transmitting the RST request:
transmitting a subsequent SYN request from the network scanner to a different TCP port at that IP address.

7. The method of claim 1, further comprising:
waiting for a delay period between transmitting the SYN request and transmitting the RST request.

8. The method of claim 7, further comprising:
setting the delay period based on a response time of another device on a same network segment as that IP address.

9. A network scanner configured to discover assets on a computer network, the network scanner comprising:
a processor; and
a memory, the memory containing instructions thereon configuring the processor to:
transmit, to each of at least a subset of internet protocol (IP) addresses of the computer network, a synchronize (SYN) request to a transmission control protocol (TCP) port on that IP address via an intermediate stateful network device, the SYN request causing the intermediate stateful network device to open a session table entry in memory; and
transmit a reset (RST) request to the TCP port on that IP address via the intermediate stateful network device, the RST request causing the intermediate stateful network device to clear the session table entry from the memory.

10. The network scanner of claim 9, wherein the instructions further configure the processor to set a time-to-live (TTL) of the RST request to be at least equal to a hop count from the network scanner to the intermediate stateful network device.

11. The network scanner of claim 10, wherein the instructions further configure the processor to set the TTL of the RST request to be less than a hop count from the network scanner to a device at that IP address.

12. The network scanner of claim 9, wherein the instructions further configure the processor to, after transmitting the RST request:
transmit a subsequent SYN request to a different TCP port at that IP address.

13. The network scanner of claim 9, wherein the instructions further configure the processor to:
wait for a delay period between transmitting the SYN request and transmitting the RST request.

14. The network scanner of claim 13, wherein the instructions further configure the processor to:
set the delay period based on a response time of another device on a same network segment as that IP address.

15. A computer network, the computer network comprising:
a network scanner comprising a processor and a memory, the memory containing instructions thereon configuring the processor to:
transmit, to each of at least a subset of internet protocol (IP) addresses of the computer network, a synchronize (SYN) request to a TCP port on that IP address;
an intermediate stateful network device, the intermediate stateful network device configured to:
forward the SYN request to the TCP port on that IP address; and
open a session table entry in memory; and
a device at that IP address, the device configured to:
transmit a reset (RST) request to the TCP port on that IP address via the intermediate stateful network device, the RST request causing the intermediate stateful network device to clear the session table entry from the memory.

16. The computer network of claim 15, wherein the RST request has a time-to-live (TTL) at least equal to a hop count from the network scanner to the intermediate stateful network device.

17. The computer network of claim 16, wherein the TTL is less than a hop count from the network scanner to the device at that IP address.

18. The computer network of claim 15, wherein the network scanner is further configured to transmit a subsequent SYN request to a different TCP port at that IP address after the device has transmitted the RST request.

19. The computer network of claim 15, wherein the device is further configured to:
wait for a delay period after the network scanner transmits the SYN request before transmitting the RST request.

20. The computer network of claim 19, wherein the device is further configured to:
set the delay period based on a response time of another device on a same network segment as that IP address.
